(19) United States
(12) Patent Application Publication
(10) Pub. No.: US 2015/0206238 A1
(43) Pub. Date: Jul. 23, 2015

(54) Principal Protector

(71) Applicant: TD Ameritrade IP Company, Inc., Omaha, NE (US)

(72) Inventors: Chenthil JEYARAJ, Chicago, IL (US); Chris CZARNOWSKI, Lombard, IL (US); Vamsi KANURI, Chicago, IL (US); Perem Sharmila Veera Pal RAJ, Chicago, IL (US); Joanne SEYL, Baltimore, MD (US)

(73) Assignee: TD Ameritrade IP Company, Inc., Omaha, NE (US)

(21) Appl. No.: 14/162,262

(22) Filed: Jan. 23, 2014

(51) Int. Cl. G06Q 40/04

(52) U.S. Cl. CPC G06Q 40/04

(57) ABSTRACT

A system, a method and a computer program product for generating a policy for a financial instrument are provided. A policy for a principal of a financial instrument is generated based on a derivative instrument. The derivative instrument is associated with a security of the financial instrument. Once generated, the policy is provided for purchase to investors, such that the policy and the financial instrument are purchased as a single product.

### BACKGROUND

Investors trading on stock exchanges invest money into different companies by buying and selling the company's stock. Along with the investment, investors also face exposure to losing a portion, if not all, of their investment due. The expose may be due to market volatility or other events outside of the investors' control. One way to minimize exposure is to provide products to investors that minimize loss to their investments.

### BRIEF SUMMARY

A system, a method and a computer program product for generating a policy for a financial instrument are provided. A policy for a principal of a financial instrument is generated based on a derivative instrument. The derivative instrument is associated with a security of the financial instrument. Once generated, the policy is provided for purchase to investors, such that the policy and the financial instrument are purchased as a single product.

Further embodiments, features, and advantages of the invention, as well as the structure and operation of the various embodiments are described in detail below with reference to accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the embodiments and to enable a person skilled in the relevant art to make and use the embodiments.

FIG. 1 is a block diagram of a client-server environment where embodiments can be implemented.

FIG. 2 is a diagram of a trading application frontend, according to an embodiment.

FIG. 3 is a block diagram of a policy protection plan, according to an embodiment.

FIG. 4 is a block diagram of a principal protector, according to an embodiment.

FIG. 5 is a flowchart of a method for generating a policy for a financial instrument, according to an embodiment.

FIG. 6 is a flowchart of a method for purchasing a policy, according to an embodiment.

FIG. 7 is a block diagram of a computer system where the embodiments may be implemented.

The embodiments will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention.

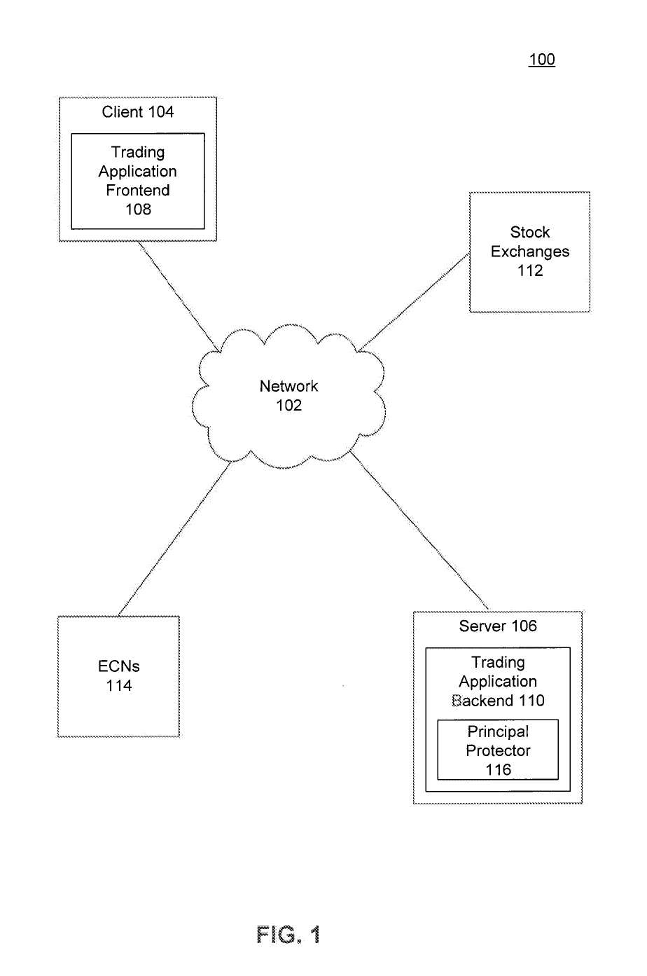

FIG. 1 is a block diagram of client-server environment 100 where embodiments can be implemented. Example environment 100 includes a network 102, client devices 104, servers 106, stock exchanges 112, and electronic communication networks 114.

Network 102 may be any network or combination of networks that can carry data communication between numerous computing devices such as client devices 104 and servers 106. Network 102 may include, but is not limited to, a local area network, metropolitan area network, and/or wide area network such as the Internet or the World Wide Web (“the Web”). To carry data communication, network 102 uses numerous protocols, such as an internet protocol (“IP), file transfer protocol (“FTP”), transmission control protocol (“TCP”), and HyperText Transfer Protocol (“HTTP”), to give a few examples. Further, intermediate web servers, gateways, or other servers may be provided between components of the system shown in FIG. 1, depending upon a particular application or environment.

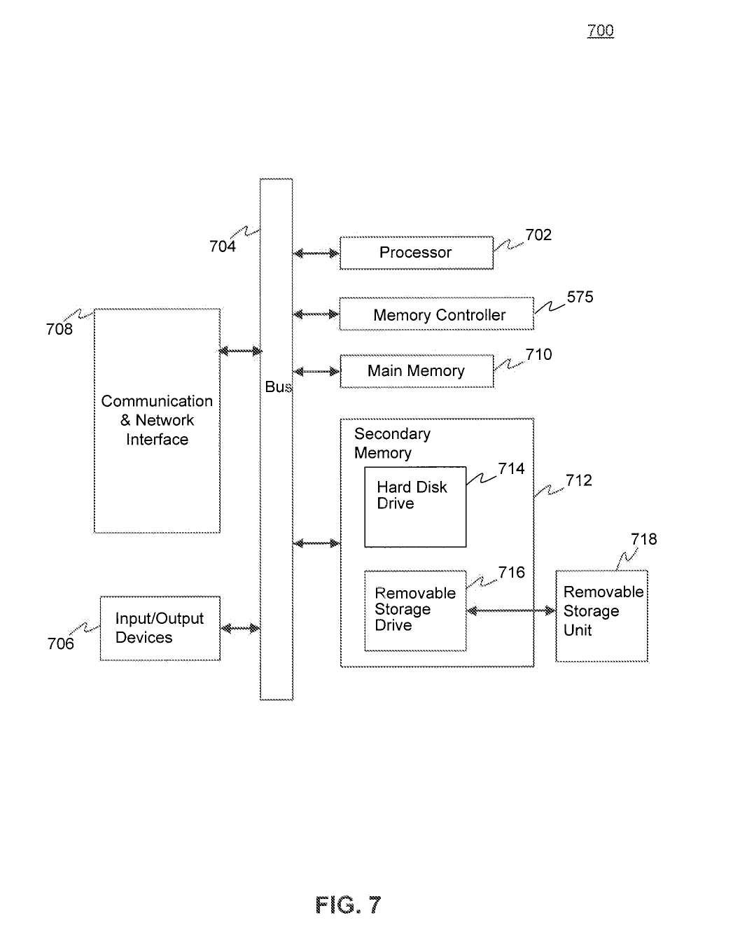

Client devices 104 are electronic devices that are controlled and/or manipulated by users. Client devices 104 are capable of requesting and receiving resources, applications, data, etc., over network 102. Example client devices 104 include personal computers, laptop computers, smartphones, tablets and any other electronic devices that can connect to network 102. Client devices 104 may have some or all components of an example computing device included in FIG. 7.

In an embodiment, client devices 104 and servers 106 execute applications, such as client-server applications. A client-server application includes an application frontend and an application backend. An application frontend executes on client device 104. An application backend executes on server 106.

In an embodiment, client device 104 may download an application frontend from server 106 or access the application frontend using the Internet. Once accessed, client device 104 presents the application frontend to a user, while the user uses the application frontend to input data into the application, view application data and/or send instructions to the application backend that executes on server 106.

Server 106 is a computing device that communicates with multiple client devices 104. Server 106 executes an application backend, sends and transmits data to client devices 104 and interfaces with databases or other data storage devices that store data. When server 106 receives requests from an application frontend accessible using client device 104, server 106 uses an appropriate application backend to process the requests and transmits a response back to client device 104, as needed. In an embodiment, data communication between client devices 104 and server 106 may be via a HyperText Markup Language (“HTML”) and include pages, scripts, images, video, embedded information (such as meta-information in hyperlinks) and/or embedded instructions (such as JavaScript scripts).

In an embodiment, an example client-server application is a trading application. In the trading application, client devices 104 include or access a trading application frontend 108 that connects to a trading application backend 110 executing on server 106. In an embodiment, trading application frontend 108 may be downloaded onto client device 104 using network 102, installed on client device 104 using external memory devices or accessed using a browser that executes on client device 104.

Trading application frontend 108 provides users, such as, investors with an interface for buying and selling financial instruments. Financial instruments are tradable assets, such as stocks, bonds, futures, options, mutual funds, annuities, etc. A user uses trading application frontend 108 to place an order to buy or sell the desired financial instrument. In an embodiment, an order includes order criteria such as a type of a financial instrument that the investor wants to buy or sell, the desired quantity, such as a number of shares and the desired bid or offer price. Once the investor places an order, trading application frontend 108 generates an order request that includes the order criteria and transmits the order request to trading application backend 110.

Trading application backend 110 communicates with trading application frontend 108 on client devices 104 and numerous trading entities, such as, stock exchanges 112 and electronic communication networks 114, to name a few examples.

Stock exchanges 112 are exchanges that provide a venue for traders, brokers, broker-dealers, etc., to trade various financial instruments. Example stock exchanges 110 include New York Stock Exchange (“NYSE”), National Association of Securities Dealers Automated Quotations (“NASDAQ”), American Stock Exchange (“AMEX”), Chicago Board Options Exchange (“CBOE”), Boston Stock Exchange (“BSE”), National Stock Exchange (“NSX”), Tokyo Stock Exchange, Euronext, London Stock Exchange (“LSE”), etc.

Electronic communication networks (“ECNs”) 114 are commuter systems that trade financial instruments outside of stock exchanges 112.

When trading application backend 110 receives an order request from trading application frontend 108, it formats the order into a format compatible with one or more stock exchanges 112 or ECNs 114 and places the order on the market at one of those venues. Once placed, the order may be executed (i.e. a purchase or sale occurs) by one or more market participants who collectively trade financial instruments using stock exchanges 110 or ECNs 112.

The price of financial instruments tends to fluctuate with the daily activity on stock exchanges 112, ECNs 114, etc. For example, a financial instrument purchased for $X at time A may be sold for $Y at time B, where the sale price $Y may be the same, less than or greater than the purchase price $X. At certain instances, the price of a financial instrument may vary drastically. The variation may be a result of daily price fluctuation due internal market forces or external market stress that occurs due to a company's earnings report, an economic forecast or a newsworthy event such as a Lehman Brothers bankruptcy or Sep. 11, 2001.

Because of price fluctuation, the financial instrument may fluctuate such that an investor stands to lose money. To limit the monetary loss, trading application backend 110 includes a principal protector 116. Principal protector 116 provides protection to an investor against the monetary loss associated with the financial instrument. In an embodiment, the provided protection may be defined in terms of a value of the financial instrument at a time of purchase and duration. For example, principal protector 116 allows an investor to purchase a protection plan, (i.e., an insurance policy) that protects a percentage of a financial instrument for a predetermined number of days.

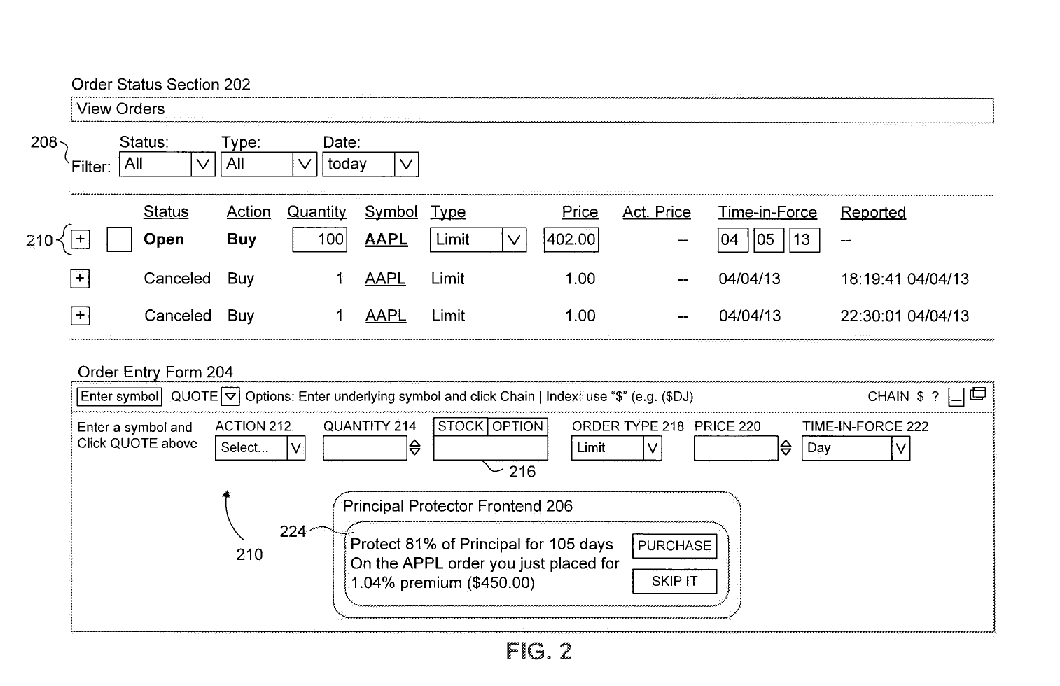

In an embodiment, an investor is able to use trading application frontend 108 to configure the desired policy protection plan for a financial instrument. The policy protection plan generates a policy for orders that the investor places on the market. FIG. 2 is a diagram 200 of a trading application frontend, according to an embodiment. In an embodiment, diagram 200 describes a policy based on a policy protection plan. The policy in diagram 200 was generated for an equity order placed on one of stock exchanges 112, though an implementation is not limited to that embodiment.

Diagram 200 includes an order status section 202, an order entry form 204 and a principal protector frontend 206.

Order status section 202 allows an investor to view orders 210 that have been placed for execution on stock exchanges 112, ECNs 112 etc., or that have been cancelled or executed.

As discussed above, orders 210 are identified using order criteria. Order criteria may be set by an investor wishing to place the order on the market. In an embodiment, order entry form 204 may be used to set order criteria for the order.

In an embodiment, an order criterion includes an action 212. Action 212 identifies whether an order is a buy or a sell order. A person skilled in the art will appreciate that a buy order identifies a number of shares an investor wishes to purchase, whereas a sell order identifies a number of shares an investor wishes to sell. The number of shares identified in order 210 may also be referred to as quantity 214.

In an embodiment, an order criterion includes a symbol 216. Symbol 216 identifies a name of the financial instrument trading on stock exchange 112. Symbol 216 may be a unique sequence of letters that is assigned to a financial instrument for trading purposes. In an embodiment, symbol 216 also indicates an underlying financial strategy associated with the instrument, such as whether symbol 216 is for purchase of an option, etc. For example, when symbol 216 is associated with a sale of a security, symbol 216 typically includes the sequence of letters assigned to the security. When symbol 216 represents an option, symbol 216 includes an underlying security, whether an option is a call (buy) or a put (sell) option, an expiration month of the option (expiration date) and an agreed upon price at an expiration date (strike price). A person of ordinary skill in the art will appreciate that an option is a contract between an option writer and an option holder to call or put an option to buy or sell a financial instrument at a strike price on expiration date.

In an embodiment, order criterion includes an order type 218. Example order type 218 includes a market order, a limit order or a stop order. For example, a market order is filled (bought or sold) according to the specified order criteria at the best price currently available on the market. In another example, a limit order is filled according to a specified price. In another example, a stop order becomes a market or a limit order after other market criteria are met, such as when a price for a security reaches a price specified in the stop order. A person skilled in the art will appreciate that the list of order types 218 above is non-exhaustive and that other order types 218 not mentioned above may also be configured using order entry form 204.

In an embodiment, order criterion includes a price 220. Example price 220 may be a buy or sell price for which an investor wishes to buy or sell order 210. If an order type 218 of order 210 is market, a price may not need to be set, as market orders execute at the best price offered on the market.

In an embodiment, order criterion also includes a time-in-force 222. Time-in-force 222 identifies how long order 210 remains active on the market before it either executes or expires. In an embodiment, time-in-force 222 may be set for duration of a trading day, or up to a particular date.

In an embodiment, order status section 202 may also display the time order 210 was executed, as time reported.

In an embodiment, orders 210 in order status section 202 can be filtered using an order filter 210. Order filter 208 filters orders according to order criteria, such as status, type and date, to name a few examples.

In an embodiment, orders 210 in order status section 202 can be sorted according to order criteria. Example order criteria includes status, action, quantity, symbol, type, price, actual price, time-in-force and time reported, to name a few examples.

Unlike conventional systems, when an investor places order 210 on the market, trading application described in FIG. 1 provides an investor with an option to buy protection for order 210. To provide protection for order 210, trade platform frontend 108 provides an interface to principal protector 116, such as principal protector frontend 206. Principal protector frontend 206 displays a policy 224 to investor and gives the investor an option to purchase policy 224.

In an embodiment, policy 224 includes policy criteria. Example policy criterion includes a percentage of the principal of the order 210 that is protected. An example principal may be the value of the order, such as quantity 214 multiplied by price 220. In an embodiment, policy criterion also includes a period of time that requires protection, such as a number of days. In another embodiment, policy criterion also includes the price of policy 224.

For example, principal protector frontend 206 displays policy 224 for a limit order placed on the market for 100 shares of Apple Inc., (symbol AAPL) at $224.00/share. The total cost of the order being $40,200.00. Policy 224 protects 81% of the principal of the limit order for 105 days at a cost of $450.00 or 1.04% of the price of the limit order. If the investor decides to purchase policy 224 displayed using principal protector frontend 206, the investor may click on the purchase button and purchase policy 224. Otherwise the investor may skip the policy and place order 210 on the market unprotected. Alternatively, the investor can also purchase policy 224 for the same or different policy criteria at a later time.

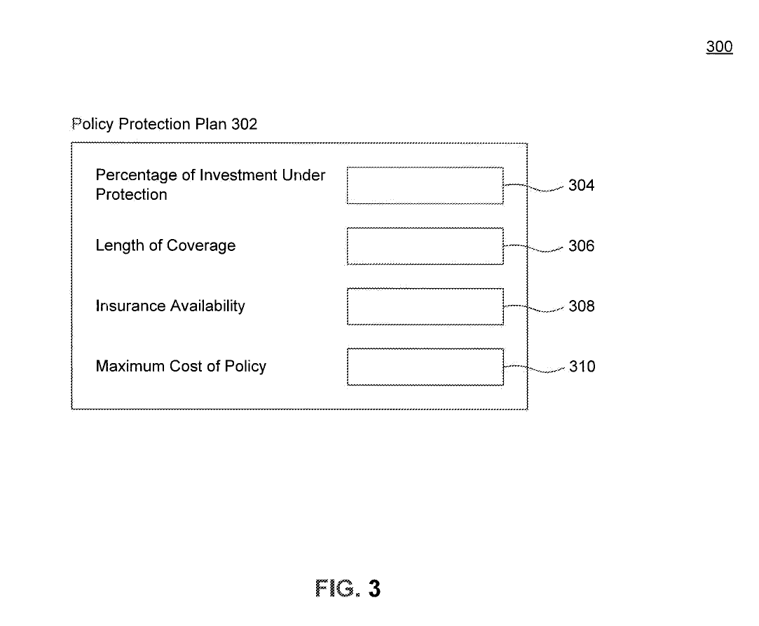

Trading application frontend 110 allows an investor to configure a protection policy plan for order 210. FIG. 3 is a block diagram 300 of a policy protection plan configured using the investor profile, according to an embodiment.

Block diagram 300 allows an investor to configure a policy protection plan 302 for policy 224 associated with orders 206 that an investor places on the market. Based on the policy protection plan 302, principal protector 116 generates policy 224 for order 210.

In an embodiment, policy protection plan 302 allows an investor to configure a percentage of investment under protection 304. For example, if the investor wants to protect 80% of the principal in order 210, an investor sets percentage of investment under protection 304 to 80%.

In an embodiment, policy protection plan 302 allows an investor to configure a length of coverage 306 for policy 224. Length of coverage 306 is an amount of time policy 224 is in effect. For example, the investor may set the length of coverage 306 to a day, a week, a month, a 100 days, etc.

In an embodiment, policy protection plan 302 also includes an insurance availability marker 306. Insurance availability marker 306 controls whether order 210 can be placed on the market without policy 224. For example, when insurance availability marker 306 is marked, trading application backend 110 places order 210 on the market only when policy 224 that fits the conditions set in policy protection plan 302 is available. If insurance availability marker 306 is not marked, trading application backend 110 places order 210 on the market and then queries trading application frontend 108 whether an investor wishes to purchase policy 224.

In an embodiment, policy protection plan 302 enables an investor to set a maximum cost 310 for policy 224. In one embodiment, maximum cost 310 may be a percentage of the principal, such as 1%, 2%, etc. In another embodiment, the maximum cost may be a monetary amount, such as, $10.00, $100.00, etc.

For example, an investor may configure policy 224 where percentage of investment under protection 304 is 80%, length of coverage 306 is three months and a maximum cost 310 is 1.25% of the of the principal. Further, based on whether insurance availability 308 marker is set, trading application backend 110 may place order 210 on the market before or after principal protector 116 determines whether an appropriate policy 224 is available.

For example, if an investor places order 210 for a 100 shares of Costco at $110/share for 105 days, policy protector frontend 206 may display policy 224 that costs $21.00 and provides protection for 105 days, and that is 0.19% of the value of order 210.

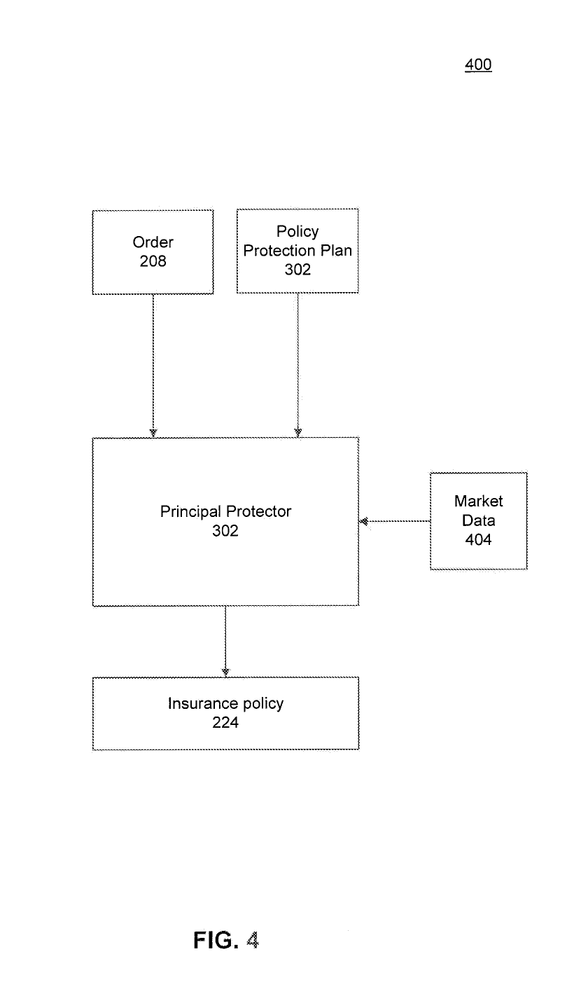

Once an investor configures order 210, principal protector 116 determines policy 224 for order 210 based on policy protection plan 302. Further, the configured policy protection plan 302 is associated with the investor's profile and can be reused for multiple orders 210. FIG. 4 is a block diagram 400 of principal protector 116, according to an embodiment.

In an embodiment, principal protector 116 uses market data 402 to determine policy 224. Market data 402 is the price and trade-related data for financial instruments that is reported by stock markets 112 and ECNs 114. A person skilled in the art will appreciate that market data 402 enables investors to know the latest price as well as the historical price trend for the financial instruments. In an embodiment, market data 402 may be received, stored and aggregated by trading application backend 110, and an investor may request market data 402 for a particular security for display on client device 104.

In one embodiment, market data 402 includes prices for derivative instruments, such as options, futures, etc., that principal protector 116 uses to price policy 224. For example, when principal protector 116 receives order 210, principal protector 116 retrieves symbol 216 included in order 210 and searches option prices in market data 402 for available options associated with symbol 216. Once principal protector 116 identifies the list of options, principal protector 116 determines whether an option exists that meets other policy protection plan 302 criteria such as percentage of investment under protection 304 and length of coverage 306. Principal protector 116 also determines whether the option is priced at or below the maximum cost of policy 310 set by the investor. When principal protector 116 identifies the option from the option list, principal protector 116 generates policy 224 that is associated with the identified option. Principal protector 116 then transmits policy 224 to client server 104, where principal protector frontend 206 displays policy 224 to the investor. Once displayed, an investor may use principal protector frontend 206 to indicate whether the investor wishes to purchase or decline policy 224. A person skilled in the art will appreciate that the above example including options is for illustrative purposes only, and that other derivative instruments may be used.

If principal protector frontend 206 receives an indication that the investor wishes to purchase policy 224, trading application frontend 108 submits a purchase request to trading application backend 110. Principal protector 116 then purchases an option associated with policy 224. In this way, if the principal value of order 210 falls below the percentage of investment under protection 302, principal protector 116 exercises the option on the investor's behalf and protects the percentage of the principal. If the principal value of order 210 remains above the investment under protection 302, principal protector 116 does not exercise the option, and the option expires.

When principal protector 116 purchases policy 224 for order 210, policy 224 may be stored in the account associated with a market participant on behalf of the investor or in the investor's account. In an embodiment where policy 224 is held by the market participant, market participant may choose to exercise the option associated with policy 224 to protect percentage of investment under protection 304 as required or request permission from the investor to do so. In an embodiment where policy 224 is held by the investor, option associated with policy 224 may be exercised by the investor to protect percentage of investment under protection 304 as required.

In an embodiment, if an investor liquidates the investment prior to the time policy 224 expires, policy 224 may be liquidated as well. For example, either market participant or the investor may sell the option associated with policy 224 on stock exchange 112.

In an embodiment, principal protector 116 may fail to identify an option from the options list that matches criteria included in policy protection plan 302. For example, principal protector 116 may fail to identify an option that is within maximum cost of policy 310 that allows protection for length of coverage 306. In this embodiment, principal protector 116 may still generate policy 224 that does not meet policy protection plan 302 criteria. The generated policy 224 may be associated with the best available option from the option list but is outside of the criteria set forth in policy protection plan 302. Once generated, principal protector 116 may transmit policy 224 to client device 104 for display using principal protector frontend 206. In this embodiment, principal protector frontend 206 may displays policy 224 to the investor with a message that policy 224 is outside of the scope of policy protection plan 302.

In an embodiment, when principal protector 116 fails to identify an option from the option list, principal protector 116 may generate a message to principal protector frontend 206 notifying the investor that policy 224 is unavailable for order 210.

In another embodiment, trading application backend 110 determines whether insurance availability 308 marker is checked in policy protection plan 302. if checked, trading application backend 110 executes order 210 when policy 224 is available for order 210. Otherwise, trading application backend 110 does not execute order 210,

In an embodiment, order 210 and policy 224 are packaged together into a single product. In this embodiment, trading application backend 110 sends the product to stock exchange 112 such that order 210 and policy 224 are transmitted to stock exchange 112 simultaneously or are not transmitted to stock exchange 112 at all. In this way, an investor is protected against price fluctuation of order 210 at the moment order 210 is transmitted to stock exchange 112, and does not incur a time period where order 210 is transmitted to exchange 112 unprotected—i.e. without policy 224.

Further, at the time an investor is ready to place order 210 and policy 224 on stock exchange 112 as a single product, principal protector 116 determines whether investor is able to obtain policy 224 for order 210 according to the investor's profile. This determination influences investor's decision with respect to placing order 210 on stock exchange 112, For example, if the investor determines that principal protector 116 cannot generate policy 224 according to the investor's profile and package order 210 and policy 224 into a single product, then the investor may forgo placing order 210 on stock exchange 112 altogether.

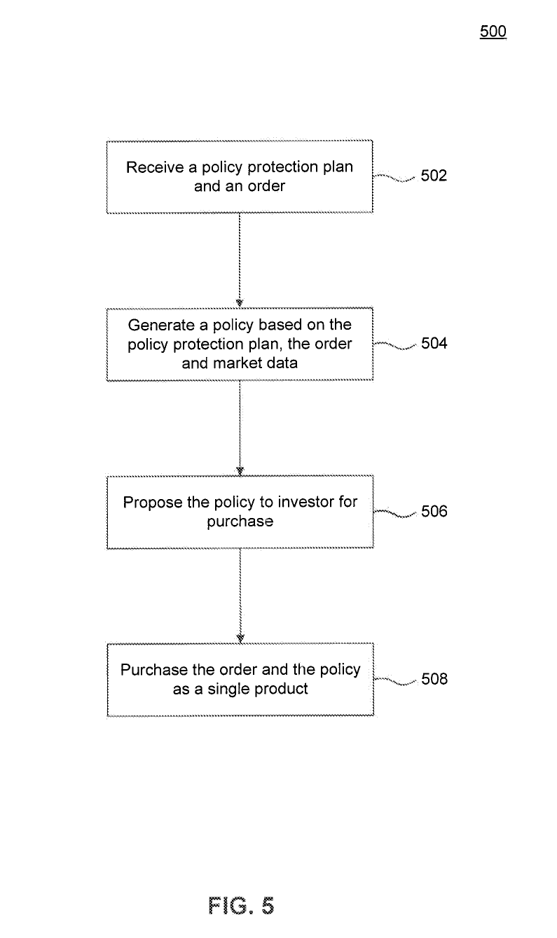

FIG. 5 is a flowchart of a method 500 for generating a policy for a financial instrument, according to an embodiment.

At operation 502, a policy protection plan and an order are received. For example, principal protector 116 receives an order 210 for a security associated with symbol 216 and policy protection plan 302.

At operation 504, a policy is generated. For example, based on symbol 216, criteria included in principal protection plan 302 and market data 402 principal protector 116 generates policy 224, as discussed in detail in method 600.

At operation 506, a policy is proposed for purchase. For example, principal protector 116 transmits policy 224 to principal protector frontend 206 where the terms of policy 224 are displayed and proposed for purchase to the investor.

At operation 508, a policy and an order are purchased as a single product. For example, trading application backend 110 places both order 210 and policy 224 on stock exchange 112 as a single product, such that order 210 is protected from price fluctuation as soon as it is placed on stock exchange 112.

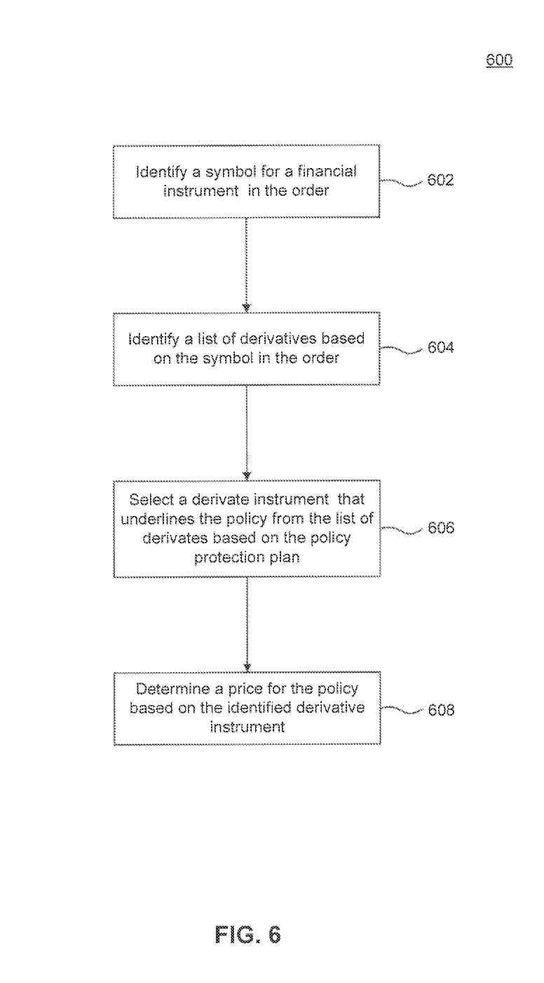

FIG. 6 is a flowchart of a method 600 for purchasing a policy, according to an embodiment.

At operation 602, a symbol is identified. For example, principal protector 116 identifies the symbol 116 associated with order 210.

At operation 604, a derivative list is identified. For example, principal protector 116 queries market data 402 received by trading application backend 110 and identifies a derivative list for the symbol identified in operation 602. As discussed above, the derivative list may be an options list.

At operation 606, a derivative instrument for a policy is selected. For example, principal protector 116 selects a derivative from the derivative list, such as an option from the option list that underlines policy 224. In an embodiment, the derivative instrument may be identified based on the criteria set in the principal protection plan 302, such as percentage of investment under protection 304, length of coverage 306 and maximum cost of policy 310. In another embodiment, principal protector 116 is unable to identify a derivative instrument based on the criteria set in the principal protection plan 302, and instead may identify a derivative instrument that best meets the criteria set in principal protection plan 302 (i.e. meets one or more criteria in principal protection plan 302.)

At operation 608, a price for the policy is determined. For example, the price for policy 224 may be the purchase price of the derivative instrument in one example. In another example, the price for policy 224 may be the purchase price of the derivative and commission.

Various embodiments described in FIGS. 1-6 can be implemented, for example, using one or more well-known computer systems, such as computer system 700 shown in FIG. 7. Computer system 700 can be any well-known computer capable of performing the functions described herein, such as computers available from an International Business Machine (“IBM”), Apple, Sun, HP, Dell, Sony, Toshiba, etc.

Computer system 700 includes one or more processors, such as a processor 702. Processor 702 may include any conventional or special purpose processor, including, but not limited to, digital signal processor (DSP), field programmable gate array (FPGA), and application specific integrated circuit (ASIC). Processor 702 is connected to a communication infrastructure or bus 704.

One or more processors 702 may also be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 700 also includes user input/output device(s) 706, such as monitors, keyboards, pointing devices, etc., which communicate with communication infrastructure 708 through user input/output interface(s). Example communication infrastructure 708 may include one or more device interconnection buses such as Ethernet, Peripheral Component Interconnect (PCI), and the like.

In an embodiment, communication infrastructure 708 enables computer system 700 to communicate and interact with any combination of remote devices, remote networks, remote entities, etc. For example, communication infrastructure 708 may allow computer system 700 to communicate with remote devices which may be wired and/or wireless, and which may include any combination of local area networks (LANs), wide area networks (WANs), the Internet, etc.

Computer system 700 also includes a main or primary memory 710, such as random access memory (RAM). Main memory 710 may include one or more levels of cache. Main memory 710 has stored therein control logic (i.e., computer software) and/or data.

Computer system 700 may also include one or more secondary storage devices or memory 712. Secondary memory 712 may include, for example, a hard disk drive 714 and/or a removable storage device or drive 716. Removable storage drive 716 may be a floppy disk drive, a magnetic tape drive, a compact disk drive, an optical storage device, tape backup device, and/or any other storage device/drive.

Removable storage drive 716 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 716 reads from and/or writes to removable storage unit 718 in a well-known manner.

According to an exemplary embodiment, secondary memory 712 may include other means, instrumentalities or other approaches for allowing computer programs and/or other instructions and/or data to be accessed by computer system 700. Such means, instrumentalities or other approaches may include, a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 708, secondary memory 710, and removable storage units 718, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 7. In particular, embodiments may operate with software, hardware, and/or operating system implementations other than those described herein.

### CONCLUSION

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer-implemented method, comprising:
receiving a request to purchase a first financial instrument;
generating a policy for a principal of the first financial instrument, wherein the policy is based on a second financial instrument; and
purchasing the first financial instrument and the policy as a single product.

2. The computer-implemented method of claim 1, wherein the second financial instrument is a derivative of the first financial instrument.

3. The computer-implemented method of claim 2, wherein the first financial instrument is an equity order and the derivative of the first financial instrument is an option for the same security as the equity order.

4. The computer-implemented method of claim 1, wherein the generating further comprises:
receiving the first financial instrument;
receiving a policy protection plan for the policy;
generating a list of a plurality of second financial instruments based on the first financial instrument and market data;
selecting the second financial instrument from the list of the plurality of the second financial instruments based on the policy protection plan; and
pricing the policy based on the second financial instrument.

5. The computer-implemented method of claim 4, wherein the selecting further comprises selecting the second financial instrument based on a criteria associated with the first financial instrument.

6. The computer-implemented method of claim 4, wherein the policy protection plan includes at least one of a portion of the principal of the first financial instrument requiring protection, a time period requiring protection and a maximum price for the policy.

7. The computer-implemented method of claim 6, wherein the first financial instrument includes a share of the security and the second financial instrument is an option for the security and wherein a price for the policy is a cost of the option.

8. The computer-implemented method of claim 7, wherein the price of the policy further comprises a commission for purchasing the option.

9. The computer-implemented method of claim 4, further comprising:
providing the policy for purchase, wherein the policy protects the portion of the principal of the first financial instrument for the time period requiring protection and the price for the policy.

10. A system, comprising:
a processor and a memory coupled to the processor;
a principal protector executing on the processor and stored in the memory and configured to
receive a request to purchase a first financial instrument;
generate a policy for a principal of a first financial instrument, wherein the policy is based on a second financial instrument; and
purchase the first financial instrument and the policy as a single product.

11. The system of claim 10, wherein the second financial instrument is a derivative of the first financial instrument.

12. The system of claim 11, wherein the first financial instrument is an equity order and the derivative of the first financial instrument is an option for the same security as the equity order.

13. The system of claim 10, wherein to generate the insurance policy the principal protector is further configured to:
receive the first financial instrument;
receive a policy protection plan for the policy;
generate a list of a plurality of second financial instruments based on the first financial instrument and market data;
select the second financial instrument from the list of the plurality of the second financial instruments based on the policy protection plan; and
price the policy based on the second financial instrument.

14. The system of claim 13, wherein to select the second financial instrument the principal protector is further configured to select the second financial instrument based on a criteria associated with the first financial instrument.

15. The system of claim 13, wherein the policy protection plan includes at least one of a portion of the principal of the first financial instrument requiring protection, a time period requiring protection and a maximum price for the policy.

16. The system of claim 15, wherein the first financial instrument includes a share of the security and the second financial instrument is an option for the security and wherein a price for the policy is a cost of the option.

17. The system of claim 16, wherein the price of the policy further comprises a commission for purchasing the option.

18. The system of claim 10, wherein the principal protector is further configured to:
provide the policy for purchase, wherein the policy protects the portion of the principal of the first financial instrument for the time period requiring protection and the price for the policy.

19. A computer-readable medium having instructions stored thereon, that when executed by a computing device, cause the computing device to perform operations, the operations comprising:
receiving a request to purchase a first financial instrument;
generating a policy for a principal of a first financial instrument, wherein the policy is based on a second financial instrument; and
purchasing the first financial instrument and the policy as a single product.

20. The computer-readable medium of claim 19, wherein the instructions that generate the insurance policy, further comprise operations comprising:
receiving the first financial instrument;
receiving a policy protection plan for the policy;
generating a list of a plurality of second financial instruments based on the first financial instrument and market data;
selecting the second financial instrument from the list of the plurality of the second financial instruments based on the policy protection plan; and
pricing the policy based on the second financial instrument.
